(19) United States
(12) Patent Application Publication
(10) Pub. No.: US 2026/0368295 A1
(43) Pub. Date: Nov. 19, 2026

(54) INFORMATION PROCESSING SYSTEM, INFORMATION PROCESSING METHOD, AND NON-TRANSITORY RECORDING MEDIUM

(71) Applicant: NEC Corporation, Tokyo (JP)

(72) Inventor: Akito SUGA, Tokyo (JP)

(73) Assignee: NEC Corporation, Tokyo (JP)

(21) Appl. No.: 19/515,832

(22) PCT Filed: Sep. 6, 2023
(86) PCT No.: PCT/JP2023/032559

§ 371 Date: Mar. 3, 2026

(51) Int. Cl. G06F 21/32; H04R 1/08

(52) U.S. Cl. CPC G06F 21/32; H04R 1/08

(57) ABSTRACT

An information processing system includes: a first acquisition unit that acquires a first feature vector based on a first echo reverberating in a first ear of a target; a second acquisition unit that acquires a second feature vector based on a second echo reverberating in a second ear of the target; and a determination unit that determines whether to authenticate the target, based on the first feature vector, the second feature vector, and a distance between the first acquisition unit and the second acquisition unit. According to such an information processing system, ear acoustic authentication can be performed with high accuracy.

### TECHNICAL FIELD

The present disclosure relates to technical fields of an information processing system, an information processing method, and a recording medium.

### BACKGROUND ART

There is known a technology/technique for performing authentication processing (so-called ear acoustic authentication) on a target, based on characteristics of an external auditory canal acquired by utilizing sound reverberation/reflection. For example, Patent Literature 1 discloses a technology/technique for performing authentication on a user, based on an authentication result of ear acoustic authentication using earphones and the movement of a user wearing the earphones.

### CITATION LIST

### Patent Literature

Patent Literature 1: International Publication No. WO 2022/195792A1

### SUMMARY

### Technical Problem

It is an example object of the present disclosure to provide an information processing system, an information processing method, and a recording medium that are configured to perform ear acoustic authentication with high accuracy.

### Solution to Problem

An information processing system according to an example aspect of the present disclosure includes: a first acquisition unit that acquires a first feature vector based on a first echo reverberating in a first ear of a target; a second acquisition unit that acquires a second feature vector based on a second echo reverberating in a second ear of the target; and a determination unit that determines whether to authenticate the target, based on the first feature vector, the second feature vector, and a distance between the first acquisition unit and the second acquisition unit.

An information processing system according to another example aspect of the present disclosure includes: an acquisition unit that acquires a first echo reverberating in a first ear of a target; an acquisition unit that acquires a second echo reverberating in a second ear of the target; an extraction unit that extracts a first feature vector from the first echo and extracts a second feature vector from the second echo; and a determination unit that determines whether to authenticate the target, based on the first feature vector, the second feature vector, and a distance between the first acquisition unit and the second acquisition unit.

An information processing method according to an example aspect of the present disclosure includes: acquiring a first feature vector based on a first echo reverberating in a first ear of a target, via a first acquisition unit; acquiring a second feature vector based on a second echo reverberating in a second ear of the target, via a second acquisition unit; and determining whether to authenticate the target, based on the first feature vector, the second feature vector, and a distance between the first acquisition unit and the second acquisition unit.

A recording medium according to an example aspect of the present disclosure is a recording medium on which a computer program that allows execution of an information processing method is recorded, the information processing method including: acquiring a first feature vector based on a first echo reverberating in a first ear of a target, via a first acquisition unit; acquiring a second feature vector based on a second echo reverberating in a second ear of the target, via a second acquisition unit; and determining whether to authenticate the target, based on the first feature vector, the second feature vector, and a distance between the first acquisition unit and the second acquisition unit.

### BRIEF DESCRIPTION OF DRAWINGS

FIG. 1 is a block diagram illustrating a hardware configuration of a first information processing system.

FIG. 2 is a block diagram illustrating a terminal configuration of the first information processing system.

FIG. 3 is a flowchart illustrating a flow of an authentication operation in the first information processing system.

FIG. 4 is a block diagram illustrating a terminal configuration of a second information processing system.

FIG. 5 is a flowchart illustrating a flow of the authentication operation in the second information processing system.

FIG. 6 is a conceptual diagram illustrating a method of measuring sound propagation time in a third information processing system.

FIG. 7 is a flowchart illustrating a flow of a distance calculation operation in the third information processing system.

FIG. 8 is a conceptual diagram illustrating a method of measuring sound propagation time in a fourth information processing system.

FIG. 9 is a flowchart illustrating a flow of the distance calculation operation in the fourth information processing system.

FIG. 10 is a block diagram illustrating configurations of a first terminal and a second terminal in a fifth information processing system.

FIG. 11 is a flowchart illustrating a flow of the distance calculation operation in the fifth information processing system.

FIG. 12 is a block diagram illustrating configurations of the first terminal and second terminal in a sixth information processing system.

FIG. 13 is a flowchart illustrating a flow of the distance calculation operation in the sixth information processing system.

FIG. 14 is a block diagram illustrating a terminal configuration of a seventh information processing system.

FIG. 15 is a flowchart illustrating a flow of the authentication operation in the seventh information processing system.

### DESCRIPTION OF EXAMPLE EMBODIMENTS

Hereinafter, an information processing system, an information processing method, and a recording medium according to example embodiments will be described with reference to the drawings.

### First Example Embodiment

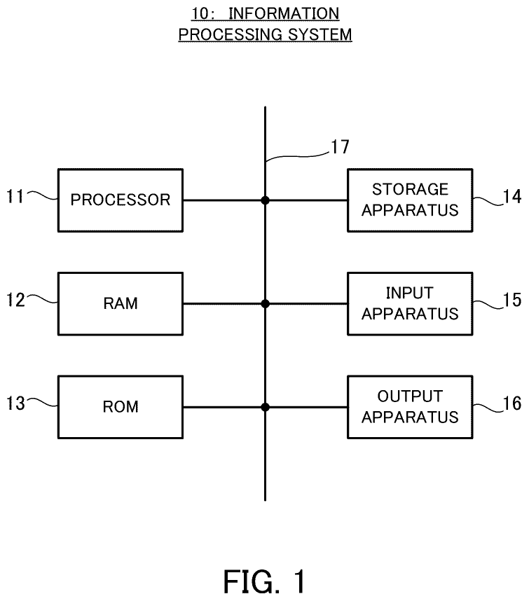

A first information processing system will be described with reference to FIG. 1 to FIG. 3.

### Hardware Configuration

First, with reference to FIG. 1, a hardware configuration of the first information processing system will be described. FIG. 1 is a block diagram illustrating the hardware configuration of the first information processing system.

As illustrated in FIG. 1, a first information processing system 10 includes a processor 11, a RAM (Random Access Memory) 12, a ROM (Read-Only Memory) 13, and a storage apparatus 14. The information processing system 10 may further include an input apparatus 15 and an output apparatus 16. The processor 11, the RAM 12, the ROM 13, the storage apparatus 14, the input apparatus 15, and the output apparatus 16 are connected via a data bus 17. The data bus 17 may be an interface other than a data bus (e.g., a LAN, a USB, etc.).

The processor 11 reads a computer program. For example, the processor 11 is configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may also acquire (i.e., read) a computer program from a not-illustrated apparatus disposed outside the information processing system 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a function block for performing processing related to ear acoustic authentication is realized in the processor 11. That is, the processor 11 may function as a controller that performs each control in the information processing system 10.

The processor 11 may be configured, for example, as a CPU (Central Processing Unit), a GPU (Graphics Processing Unit), a FPGA (field-programmable gate array), a DSP (Digital Signal Processor), an ASIC (Application Specific Integrated Circuit), or a quantum processor. The processor 11 may be configured by using one of them, or a plurality of them in parallel.

The RAM 12 temporarily stores the computer program to be executed by the processor 11. The RAM 12 temporarily stores data that are temporarily used by the processor 11 when the processor 11 is executing the computer program. The RAM 12 may be, for example, a D-RAM (Dynamic Random Access Memory) or a SRAM (Static Random Access Memory). In addition, another type of volatile memory may be used in place of the RAM 12.

The ROM 13 stores the computer program to be executed by the processor 11. The ROM 13 may also store other fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the information processing system 10 for a long time. The storage apparatus 14 may operate as a transitory storage apparatus of the processor 11. The storage apparatus may store therein the computer program to be executed by the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a part of a smartphone, a tablet terminal, an earphone-type terminal, a watch-type terminal, an eyeglass-type or goggle-type HMD (Head Mounted Display) terminal, or the like. The input apparatus 15 may be an apparatus that allows audio input/voice input, including a microphone, for example.

The output apparatus 16 is an apparatus that outputs information about the information processing system 10 to the outside. For example, the output apparatus 16 may be a display apparatus (e.g., a display) that is configured to display the information about the information processing system 10. The output apparatus 16 may also be a speaker or the like that is configured to audio-output the information about the information processing system 10. The output apparatus 16 may be configured as a part of a smartphone, a tablet terminal, an earphone-type terminal, a watch-type terminal, an eyeglass-type or goggle-type HMD (Head Mounted Display) terminal, or the like.

The first information processing system 10 includes a first terminal, a second terminal, and a third terminal, as described later. Each of the components described in FIG. 1 may be configured to be included in at least one of the first terminal, the second terminal, and the third terminal provided in the first information processing system 10. Furthermore, a part of the components described in FIG. 1 may be configured to be included in an external apparatus (e.g., an external server or cloud, etc.) that is different from the first terminal, the second terminal, and the third terminal.

### Terminal Configuration

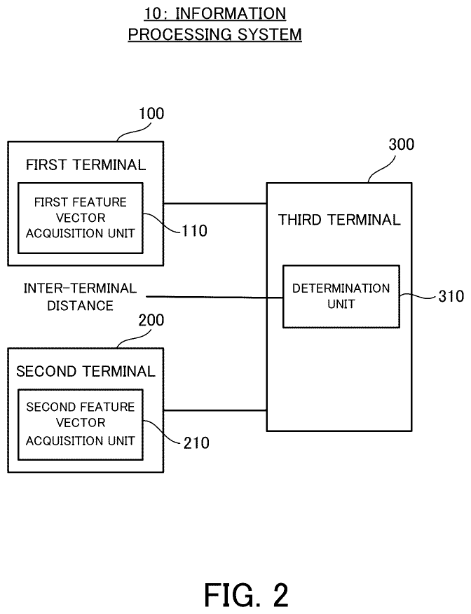

Next, with reference to FIG. 2, a terminal configuration of the first information processing system 10 will be described. FIG. 2 is a block diagram illustrating the terminal configuration of the first information processing system.

In FIG. 2, the first information processing system 10 includes a first terminal 100, a second terminal 200, and a third terminal 300. The first terminal 100 and the second terminal 200 are connected to the third terminal 300, for example, via wireless communication, and are configured to transmit and receive information to or from the third terminal 300. Furthermore, the first terminal 100 and the second terminal 200 may also be configured to transmit and receive information with each other via wireless communication or the like.

Each of the first terminal 100 and the second terminal 200 is configured, for example, as an earphone-type hearable terminal. The first terminal 100 and the second terminal 200 are configured as terminals respectively corresponding to different ears. For example, the first terminal 100 may be configured as an earphone-type terminal for a right ear, and the second terminal 200 may be configured as an earphone-type terminal for a left ear.

The first terminal 100 includes a first feature vector acquisition unit 110 as a processing block for realizing its functions. The first feature vector acquisition unit 110 is configured to acquire a first feature vector based on a first echo reverberating inside a first ear of a target. For example, the first feature vector acquisition unit 110 controls the first terminal 100, which is worn in the target's first ear, to acquire an echo signal including the characteristics/features of the target's first ear (specifically, the characteristics/features of an internal shape of the ear). More specifically, the first feature vector acquisition unit 110 controls the first terminal 100 to transmit a sound wave into the target's first ear, and acquires an echo signal based on an echo of the transmitted sound wave. The first feature vector acquisition unit 110 then extracts the first feature vector from the acquired echo signal. Meanwhile, the second terminal 200 includes a second feature vector acquisition unit 210 as a processing block for realizing its functions. The second feature vector acquisition unit 210 is configured to acquire a second feature vector based on a second echo reverberating inside a second ear of the target, through an operation similar to that of the first feature vector acquisition unit 110 described above. The first feature vector and the second feature vector are parameters respectively indicating the characteristics of the internal shape of the target's first and second ears (i.e., the right and left ears), and are used for ear acoustic authentication in a determination unit 310 described later.

The third terminal 300 is configured as a portable terminal such as, for example, a smartphone, a tablet terminal, a watch-type terminal, and an eyeglass-type or goggle-type HMD terminal, or as a terminal such as a personal computer and a server. The third terminal 300 includes a determination unit 310 as a processing block for realizing its functions. The determination unit 310 is configured to receive the first feature vector from the first feature vector acquisition unit 110 in the first terminal 100. Furthermore, the determination unit 310 is configured to receive the second feature vector from the second feature vector acquisition unit 210 in the second terminal 200. Additionally, the determination unit 310 is configured to acquire an inter-terminal distance, which is a distance between the first terminal 100 and the second terminal 200. The inter-terminal distance may be a value calculated, for example, by an apparatus external to the system. Alternatively, the inter-terminal distance may be a value calculated at any one of the first terminal 100, the second terminal 200, and the third terminal. A configuration for calculating the inter-terminal distance will be described in detail in another example embodiment later.

The determination unit 310 is configured to determine whether to authenticate the target, based on the first feature vector received from the first feature vector acquisition unit 110, the second feature vector received from the second feature vector acquisition unit 210, and the inter-terminal distance (i.e., the distance between the first terminal 100 and the second terminal 200). Specifically, the determination unit 310 determines whether or not the first feature vector and the second feature vector match the feature quantities of a registered user that are registered in advance. For example, the determination unit 310 determines whether or not a degree of match between the first and second feature quantities and the feature quantities of a registered user exceeds a predetermined determination threshold. Furthermore, the determination unit 310 determines whether or not the inter-terminal distance is a normal value. For example, the determination unit 310 determines whether or not the inter-terminal distance falls within a predetermined range. This predetermined range is a threshold for determining whether or not the first terminal 100 and the second terminal 200 are attached to the target's right ear and left ear, respectively, and is set, for example, based on an average distance between a human's right and left ears or the like.

The determination unit 310 may determine whether to authenticate the target, based on a result of the determination using the first feature vector and the second feature vector described above, and a result of the determination using the inter-terminal distance. For example, the determination unit 310 may determine that the target is a registered user, in a case where the degree of match between the first and second feature quantities and the feature quantities of the registered user exceeds the predetermined determination threshold, and in a case where the inter-terminal distance falls within the predetermined range. On the other hand, the determination unit 310 may determine that the target is not a registered user, in a case where the inter-terminal distance does not fall within the predetermined range, even if the degree of match between the first and second feature quantities and the feature quantities of the registered user exceeds the predetermined determination threshold. Furthermore, the determination unit 310 may determine that the target is not a registered user, in a case where the degree of match between the first and second feature quantities and the feature quantities of the registered user does not exceed the predetermined determination threshold, even if the inter-terminal distance falls within the predetermined range.

The determination unit 310 may have a function of outputting a determination result regarding whether to authenticate the target. For example, the determination unit 310 may be configured to display the determination result on a display, or audio-output it via a speaker. Furthermore, the determination unit 310 may permit a predetermined operation on the third terminal 300, in a case where it determines that the target is a registered user. The predetermined operation may include all operations that are executable on the third terminal 300, or may be limited to a part of the operations that are executable on the third terminal 300. For example, in a case where the third terminal 300 is configured as a smartphone, it may be configured such that a lock screen of the smartphone is unlocked on the condition that the target is determined to be a registered user. Alternatively, it may be configured such that a specific application on the smartphone is usable on the condition that the target is determined to be a registered user.

Furthermore, the function of the determination unit 310 described above may be provided in one of the first terminal 100 and the second terminal 200. That is, the determination unit 310 may be provided in the first terminal 100 or in the second terminal 200. In this case, the first information processing system 10 may be configured without including the third terminal 300.

### Authentication Operation

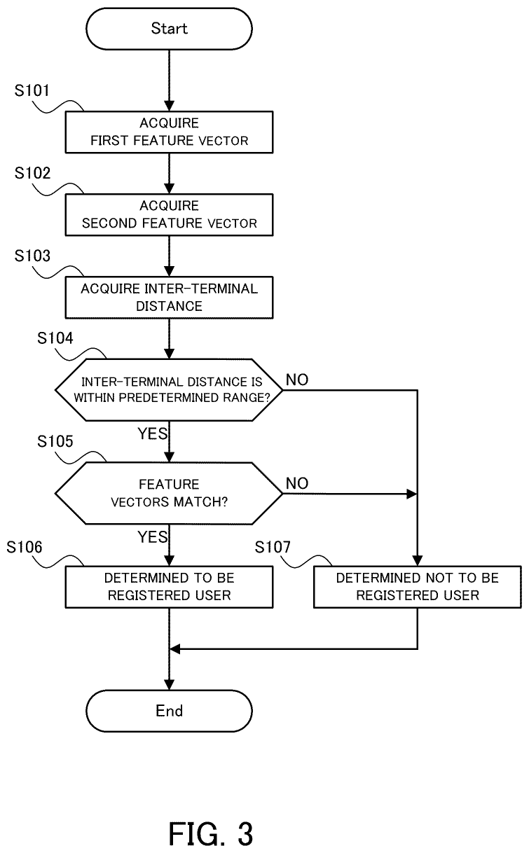

Next, with reference to FIG. 3, a flow of an authentication operation in the first information processing system 10 (i.e., an operation of acquiring the first feature vector, the second feature vector, and the inter-terminal distance, and determining whether to authenticate the target) will be described. FIG. 3 is a flowchart illustrating the flow of the authentication operation in the first information processing system.

As illustrated in FIG. 3, when the authentication operation by the first information processing system 10 is started, the first feature vector acquisition unit 110 in the first terminal 100 first acquires the first feature vector based on the first echo reverberating in the target's first ear (Step S101). Furthermore, the second feature vector acquisition unit 210 in the second terminal 200 acquires the second feature vector based on the second echo reverberating in the target's second ear (Step S102). Note that the aforementioned Steps S101 and S102 may be performed sequentially in any order or simultaneously in parallel. Each of the first feature vector and the second feature vector is outputted to the determination unit 310 in the third terminal 300.

Then, the determination unit 310 acquires the inter-terminal distance, which is the distance between the first terminal 100 and the second terminal 200 (Step S103). Then, the determination unit 310 determines whether or not the inter-terminal distance is within a predetermined range (Step S104). In a case where the inter-terminal distance is not within the predetermined range (Step S104: NO), the determination unit 310 determines that the target is not a registered user (Step S107). In a case where the inter-terminal distance is not within the predetermined range, it can be determined that the target may not be wearing the first terminal 100 and the second terminal 200 on their right and left ears, respectively (e.g., fraud such as impersonation may be attempted). Therefore, the determination unit 310 may determine that the target is not a registered user in a case where the inter-terminal distance is not within the predetermined range.

In a case where the inter-terminal distance is within the predetermined range (Step S104: YES), the determination unit 310 determines whether or not the first and second feature quantities match the feature quantities of a registered user that are registered in advance (Step S105). In a case where the first and second feature quantities match the feature quantities of a registered user (Step S105: YES), the determination unit 310 determines that the target is a registered user (Step S106). On the other hand, in a case where the first and the second feature quantities do not match the feature quantities of a registered user (Step S105: NO), the determination unit 310 determines that the target is not a registered user (Step S107).

### Technical Effect

Next, a technical effect obtained by the first information processing system 10 will be described.

As described in FIG. 1 to FIG. 3, in the first information processing system 10, it is determined whether to authenticate the target, based on the first feature vector acquired in the first terminal 100, the second feature vector acquired in the second terminal 200, and the distance between the first terminal 100 and the second terminal 200. This enables high-accuracy ear acoustic authentication. For example, authentication using only the first feature vector and the second feature vector may not prevent impersonation by others who have fraudulently obtained the first feature vector and the second feature vector, or the like. However, since the first information processing system also uses the inter-terminal distance between the first terminal 100 and the second terminal for the authentication, it is possible to effectively prevent/control fraud in the authentication. For instance, in a case where the first terminal 100 and the second terminal 200 are not worn in the right and left ears, respectively, the inter-terminal distance becomes an abnormal value. In such a case, fraud is suspected, and thus, the authentication for the target may be prevented from succeeding.

### Second Example Embodiment

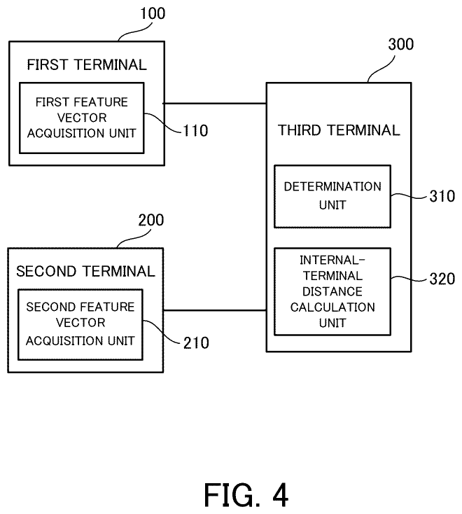

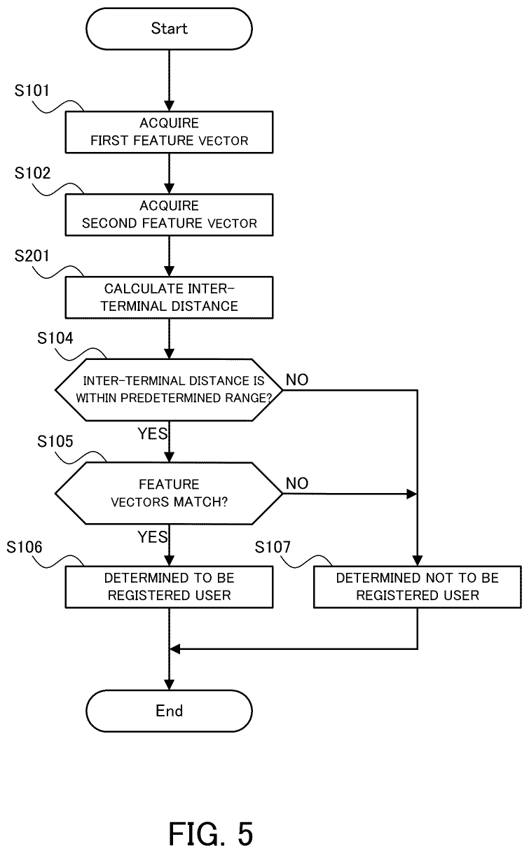

A second information processing system 10 will be described with reference to FIG. 4 and FIG. 5. The second information processing system 10 partially differs from the first information processing system 10 described above only in its configuration and operation, and may be the same as the first information processing system 10 in the other parts. Therefore, the following description will focus on the parts differing from the first example embodiment, omitting explanations for other overlapping parts as appropriate.

### Terminal Configuration

First, with reference to FIG. 4, a terminal configuration of the second information processing system 10 will be described. FIG. 4 is a block diagram illustrating the terminal configuration of the second information processing system. Note that in FIG. 4, the same reference numerals are used for the same components as those illustrated in FIG. 2.

In FIG. 4, the second information processing system 10 includes the first terminal 100, the second terminal 200, and the third terminal 300. The third terminal 300 in the second information processing system 10 includes, as processing blocks for realizing its functions, the determination unit 310 and an inter-terminal distance calculation unit 320. That is, the third terminal 300 in the second information processing system 10 further includes the inter-terminal distance calculation unit 320 in addition to the configuration described in the first example embodiment (see FIG. 2).

The inter-terminal distance calculation unit 320 is configured to calculate the inter-terminal distance, which is the distance between the first terminal 100 and the second terminal 200. A method for calculating the inter-terminal distance by the inter-terminal distance calculation unit 320 is not particularly limited. A specific example of the method for calculating the inter-terminal distance will be described in detail in another example embodiment later.

The function of the inter-terminal distance calculation unit 320 may be provided in one of the first terminal 100 and the second terminal 200. That is, the inter-terminal distance calculation unit 320 may be provided in the first terminal 100 or in the second terminal 200. In this case, the second information processing system 10 may be configured without including the third terminal 300.

### Authentication Operation

Next, with reference to FIG. 5, a flow of the authentication operation in the second information processing system 10 will be described. FIG. 5 is a flowchart illustrating the flow of the authentication operation in the second information processing system. Note that in FIG. 5, the same reference numerals are used for the same steps as those illustrated in FIG. 3.

As illustrated in FIG. 5, when the authentication operation by the second information processing system 10 is started, the first feature vector acquisition unit 110 in the first terminal 100 first acquires the first feature vector based on the first echo reverberating in the target's first ear (Step S101). Furthermore, the second feature vector acquisition unit 210 in the second terminal 200 acquires the second feature vector based on the second echo reverberating in the target's second ear (Step S102). Each of the first feature vector and the second feature vector is outputted to the determination unit 310 in the third terminal 300.

Then, the inter-terminal distance calculation unit 320 calculates the inter-terminal distance, which is the distance between the first terminal 100 and the second terminal 200 (Step S201). The inter-terminal distance calculated by the inter-terminal distance calculation unit 320 is outputted to the determination unit 310 in the third terminal 300.

Then, the determination unit 310 determines whether or not the inter-terminal distance is within a predetermined range (Step S104). In a case where the inter-terminal distance is not within the predetermined range (Step S104: NO), the determination unit 310 determines that the target is not a registered user (Step S107).

In a case where the inter-terminal distance is within the predetermined range (Step S104: YES), the determination unit 310 determines whether or not the first and second feature quantities match the feature quantities of a registered user that are registered in advance (Step S105). In a case where the first and second feature quantities match the feature quantities of a registered user (Step S105: YES), the determination unit 310 determines that the target is a registered user (Step S106). On the other hand, in a case where the first and the second feature quantities do not match the feature quantities of a registered user (Step S105: NO), the determination unit 310 determines that the target is not a registered user (Step S107).

### Technical Effect

Next, a technical effect obtained by the second information processing system 10 will be described.

As described in FIG. 4 and FIG. 5, in the second information processing system 10, the inter-terminal distance is calculated by the inter-terminal distance calculation unit 320. This enables more appropriate execution of authentication processing using the inter-terminal distance.

### Third Example Embodiment

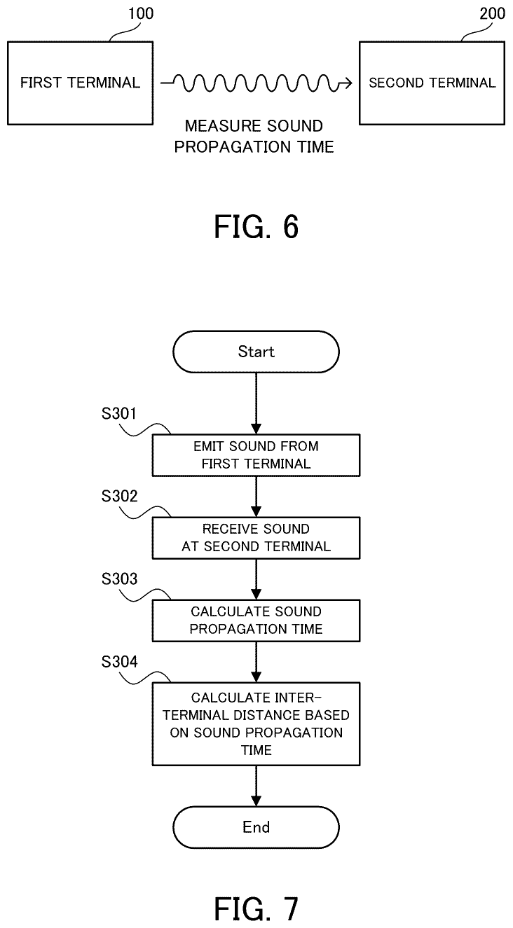

A third information processing system 10 will be described with reference to FIG. 6 and FIG. 7. Note that the third information processing system 10 partially differs from the second information processing system 10 described above only in its configuration and operation, and may be the same as the second information processing system 10 in the other parts. Therefore, the following description will focus on the parts differing from the already described example embodiments, omitting explanations for other overlapping parts as appropriate.

### Terminal Configuration

First, with reference to FIG. 6, a terminal configuration of the third information processing system 10 will be described. FIG. 6 is a conceptual diagram illustrating a method for measuring sound propagation time in the third information processing system.

As illustrated in FIG. 6, the third information processing system 10 measures sound propagation time between the first terminal 100 and the second terminal 200. For example, a speaker provided in the first terminal 100 emits sound. Then, a microphone provided in the second terminal 200 receives the sound emitted from the first terminal 100. By performing this operation, a time from when sound is emitted from the first terminal 100 to when it is received by the second terminal 200, may be calculated as the sound propagation time between the first terminal 100 and the second terminal 200. To more accurately calculate the sound propagation time, the aforementioned operation may be repeated. In this case, the average of the measured times may be treated as the sound propagation time.

The sound emitted from the first terminal 100 may be transmitted to the second terminal 200 via bone conduction. For example, the sound emitted from the first terminal 100 worn in the target's right ear, may be transmitted through the target's ear or facial bones and received by the second terminal 200 worn in the target's left ear. Using bone conduction allows accurate measurement of the sound propagation time even when ambient noise is relatively loud.

Note that the above example describes a configuration in which sound is emitted from the first terminal 100 toward the second terminal 200; however, the system may also be configured to emit sound from the second terminal 200 toward the first terminal 100. That is, there is no particular limitation on which terminal emits sound and which receives it. Furthermore, the system may be configured to emit sound from both the first terminal 100 and the second terminal 200. It may then measure the sound propagation time by repeatedly performing the operation of emitting sound from the first terminal 100 to the second terminal 200 and the operation of emitting sound from the second terminal 200 to the first terminal 100.

The inter-terminal distance calculation unit 320 in the third information processing system 10 is configured to calculate the distance between the first terminal 100 and the second terminal 200, based on the sound propagation time between the first terminal 100 and the second terminal 200 described above. The sound propagation time between the first terminal 100 and the second terminal 200 increases as the distance between the first terminal 100 and the second terminal 200 increases. Therefore, by knowing a relation between the sound propagation time and the inter-terminal distance beforehand, the inter-terminal distance may be calculated from the measured sound propagation time.

### Distance Calculation Operation

Next, with reference to FIG. 7, a flow of a distance calculation operation in the third information processing system 10 (i.e., an operation corresponding to the step S201 in FIG. 5 for calculating the inter-terminal distance) will be described. FIG. 7 is a flowchart illustrating the flow of the distance calculation operation in the third information processing system.

As illustrated in FIG. 7, when the distance calculation operation in the third information processing system 10 is started, the first terminal 100 first emits sound (step S301). Then, the second terminal 200 receives the sound emitted from the first terminal 100 (step S302).

Then, the inter-terminal distance calculation unit 320 calculates the sound propagation time between the first terminal 100 and the second terminal 200 (Step S303). Specifically, the inter-terminal distance calculation unit 320 calculates the time required from when the first terminal 100 emits the sound to when the second terminal 200 receives it.

Then, the inter-terminal distance calculation unit 320 calculates the distance between the first terminal 100 and the second terminal 200, based on the sound propagation time between the first terminal 100 and the second terminal 200 (step S304). The inter-terminal distance calculated by the inter-terminal distance calculation unit 320 is then outputted to the determination unit 310.

### Technical Effect

Next, a technical effect obtained by the third information processing system 10 will be described.

As described in FIG. 6 and FIG. 7, in the third information processing system 10, the inter-terminal distance is calculated based on the sound propagation time between the first terminal 100 and the second terminal 200. This enables accurate calculation of the inter-terminal distance with a simple configuration.

### Fourth Example Embodiment

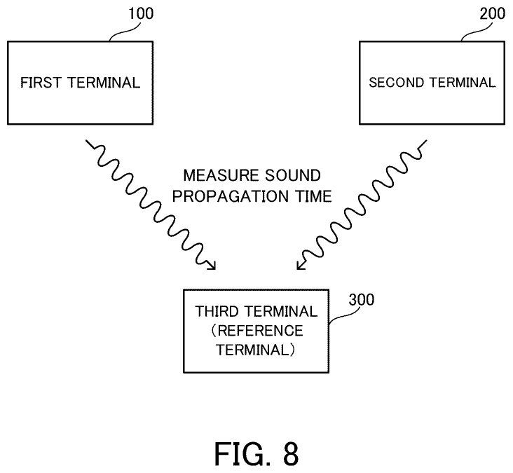

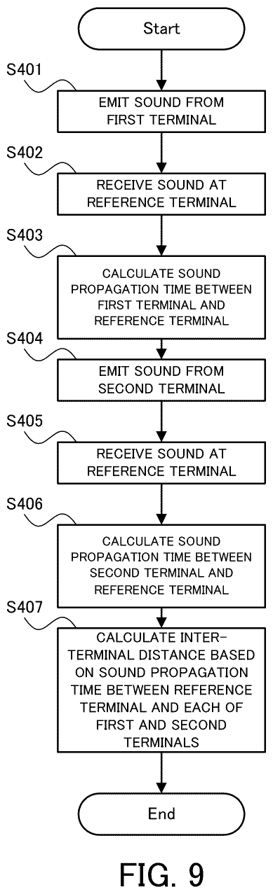

A fourth information processing system 10 will be described with reference to FIG. 8 and FIG. 9. Note that the fourth information processing system 10 partially differs from the second information processing system 10 described above only in its configuration and operation, and may be the same as the second information processing system 10 in the other parts. Therefore, the following description will focus on the parts differing from the already described example embodiments, omitting explanations for other overlapping parts as appropriate.

### Terminal Configuration

First, with reference to FIG. 8, a terminal configuration of the fourth information processing system 10 will be described. FIG. 8 is a conceptual diagram illustrating a method for measuring sound propagation time in the fourth information processing system.

As illustrated in FIG. 8, the fourth information processing system 10 measures sound propagation time between a reference terminal and each of the first terminal 100 and the second terminal 200. The reference terminal may be any terminal that is different from the first terminal 100 and the second terminal 200. Therefore, in a case where the fourth information processing system 10 includes the third terminal 300, the third terminal 300 may be treated as the reference terminal. The following will be described on the assumption that the third terminal 300 is the reference terminal.

The fourth information processing system measures the sound propagation time between the first terminal 100 and the third terminal 300. For example, a speaker provided in the first terminal 100 emits sound. Then, a microphone provided in the third terminal 300 receives the sound emitted from the first terminal 100. By performing this operation, a time from when sound is emitted from the first terminal 100 to when it is received by the third terminal 300, may be calculated as the sound propagation time between the first terminal 100 and the third terminal 300.

In the fourth information processing system, the sound propagation time between the second terminal 200 and the third terminal 300 is further measured. For example, a speaker provided in the second terminal 200 emits sound. Then, a microphone provided in the third terminal 300 receives the sound emitted from the second terminal 200. By performing this operation, a time from when sound is emitted from the second terminal 200 to when it is received by the third terminal 300, may be calculated as the sound propagation time between the second terminal 100 and the third terminal 300.

To more accurately calculate the sound propagation time, the aforementioned operation of emitting and receiving sound may be repeated. In this case, the average of the measured times may be treated as the sound propagation time. Furthermore, in a case where the third terminal 300 is a terminal used in contact with the target, or in a case where the third terminal 300 can be contacted with the target, it is also possible to measure the sound propagation time using bone conduction, as described in the second example embodiment.

The above example describes a configuration in which sound is emitted from the first terminal 100 and the second terminal 200 toward the third terminal 300; however, the system may also be configured to emit sound from the third terminal 300 toward the first terminal 100 and the second terminal 200. Furthermore, the system may be configured to emit sound from the first terminal 100 and the second terminal 200, and from the third terminal 300. It may then measure the sound propagation time by repeatedly performing the operation of emitting sound from the first terminal 100 and the second terminal 200 to the third terminal 300 and the operation of emitting sound from the third terminal 300 to the first terminal 100 and the second terminal 200.

The inter-terminal distance calculation unit 320 in the fourth information processing system 10 is configured to calculate the distance between the first terminal 100 and the second terminal 200, based on the sound propagation time between the first terminal 100 and the third terminal 300, and the sound propagation time between the second terminal 200 and the third terminal 300 described above. The sound propagation time between the terminals increases as the distance between the terminals increases. Therefore, the distance between the first terminal 100 and the third terminal 300 may be calculated using the sound propagation time between the first terminal 100 and the third terminal 300. Similarly, the distance between the second terminal 200 and the third terminal 300 may be calculated using the sound propagation time between the second terminal 200 and the third terminal 300. Then, using the distance between the first terminal 100 and the third terminal 300 and the distance between the second terminal 200 and the third terminal 300, it is possible to calculate the distance between the first terminal 100 and the second terminal 200 (i.e., the inter-terminal distance), for example, in a manner of triangulation.

### Distance Calculation Operation

Next, with reference to FIG. 9, a flow of the distance calculation operation in the fourth information processing system 10 will be described. FIG. 9 is a flowchart illustrating the flow of the distance calculation operation in the fourth information processing system.

As illustrated in FIG. 9, when the distance calculation operation in the fourth information processing system 10 is started, the first terminal 100 first emits sound (Step S401). Then, the third terminal 300, which is the reference terminal, receives the sound emitted from the first terminal 100 (Step S402). Subsequently, the inter-terminal distance calculation unit 320 calculates the sound propagation time between the first terminal 100 and the third terminal 300 (Step S403).

Then, the second terminal 200 emits sound (Step S404). Then, the third terminal 300, which is the reference terminal, receives the sound emitted from the second terminal 200 (Step S405). Subsequently, the inter-terminal distance calculation unit 320 calculates the sound propagation time between the second terminal 200 and the third terminal 300 (Step S406).

Then, the inter-terminal distance calculation unit 320 calculates the distance between the first terminal 100 and the second terminal 200, based on the sound propagation time between the first terminal 100 and the third terminal 300, and the sound propagation time between the second terminal 200 and the third terminal 300 (step S407). The inter-terminal distance calculated by the inter-terminal distance calculation unit 320 is then outputted to the determination unit 310.

### Technical Effect

Next, a technical effect obtained by the fourth information processing system 10 will be described.

As described in FIG. 8 and FIG. 9, in the fourth information processing system 10, the inter-terminal distance is calculated based on the sound propagation time between the first terminal 100 and the third terminal 300, and the sound propagation time between the second terminal 200 and the third terminal 300. This enables accurate calculation of the inter-terminal distance with a simple configuration. Furthermore, especially in the fourth information processing system 10, it is possible to appropriately calculate the inter-terminal distance using the propagation time of the sound to the third terminal 300, which is the reference terminal, even in a case where the sound propagation time between the first terminal 100 and the second terminal 200 cannot be measured, as in the third information processing system (see FIG. 6).

### Fifth Example Embodiment

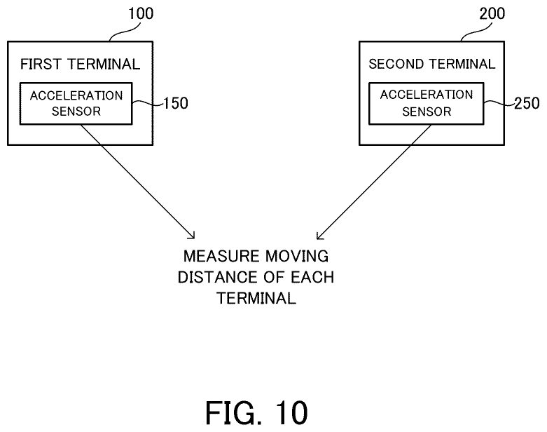

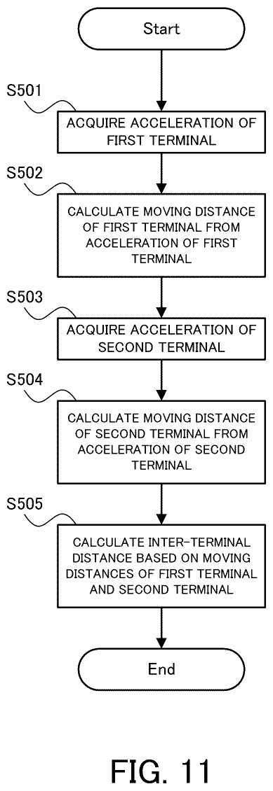

A fifth information processing system 10 will be described with reference to FIG. 10 and FIG. 11. Note that the fifth information processing system 10 partially differs from the second information processing system 10 described above only in its configuration and operation, and may be the same as the second information processing system 10 in the other parts. Therefore, the following description details only the parts differing from the already described example embodiments, omitting explanations for other overlapping parts as appropriate.

### Terminal Configuration

First, with reference to FIG. 10, a terminal configuration of the fifth information processing system 10 will be described. FIG. 10 is a block diagram illustrating configurations of the first terminal and the second terminal in the fifth information processing system.

As illustrated in FIG. 10, the fifth information processing system 10 includes an acceleration sensor 150 in the first terminal 100. The acceleration sensor 150 is configured to detect the acceleration of the first terminal 100. Furthermore, the fifth information processing system 10 also includes an acceleration sensor 250 in the second terminal 200. The acceleration sensor 250 is configured to detect the acceleration of the second terminal 200.

The inter-terminal distance calculation unit 320 in the fifth information processing system is configured to calculate a moving distance of the first terminal 100, based on the acceleration detected by the acceleration sensor 150 in the first terminal 100. Furthermore, the inter-terminal distance calculation unit 320 is configured to calculate a moving distance of the second terminal 200, based on the acceleration detected by the acceleration sensor 250 in the second terminal 200. The inter-terminal distance calculation unit 320 is configured to calculate the inter-terminal distance, which is the distance between the first terminal 100 and the second terminal 200, based on the moving distance of the first terminal 100 and the moving distance of the second terminal 200. For example, the inter-terminal distance calculation unit 320 brings the first terminal 100 and the second terminal 200 into contact with each other, setting the position in that state as an initial position. The inter-terminal distance calculation unit 320 then calculates the inter-terminal distance, based on the moving distance of the first terminal 100 from the initial position and the moving distance of the second terminal 200 from the initial position.

The above example describes a configuration in which the acceleration sensors 150 and 160 are provided in both the first terminal 100 and the second terminal 200; however, the acceleration sensor may be provided in only one of the first terminal 100 and the second terminal 200. In this case, only the moving distance of one of the first terminal 100 and the second terminal 200 is measured, but if the other terminal is prevented from moving, it is possible to calculate the inter-terminal distance.

### Distance Calculation Operation

Next, with reference to FIG. 11, a flow of the distance calculation operation in the fifth information processing system 10 will be described. FIG. 11 is a flowchart illustrating the flow of the distance calculation operation in the fifth information processing system.

As illustrated in FIG. 11, when the distance calculation operation in the fifth information processing system 10 is started, the inter-terminal distance calculation unit 320 first acquires the acceleration detected by the acceleration sensor 150 in the first terminal 100 (Step S501). Then, the inter-terminal distance calculation unit 320 calculates the moving distance of the first terminal 100 based on the acquired acceleration of the first terminal 100 (Step S502).

Similarly, the inter-terminal distance calculation unit 320 acquires the acceleration detected by the acceleration sensor 250 in the second terminal 200 (step S503). Then, the inter-terminal distance calculation unit 320 calculates the moving distance of the second terminal 200 based on the acquired acceleration of the second terminal 200 (step S504).

Then, the inter-terminal distance calculation unit 320 calculates the inter-terminal distance, which is the distance between the first terminal 100 and the second terminal 200, based on the moving distance of the first terminal 100 and the moving distance of the second terminal 200 (Step S505). The inter-terminal distance calculated by the inter-terminal distance calculation unit 320 is then outputted to the determination unit 310.

### Technical Effect

Next, a technical effect obtained by the fifth information processing system 10 will be described.

As described in FIG. 10 and FIG. 11, in the fifth information processing system 10, the moving distances of the first terminal 100 and the second terminal 200 are measured using the acceleration sensors 150 and 250, and the inter-terminal distance is calculated based on the measured moving distances of the terminals. This enables accurate calculation of the inter-terminal distance with a simple configuration.

### Sixth Example Embodiment

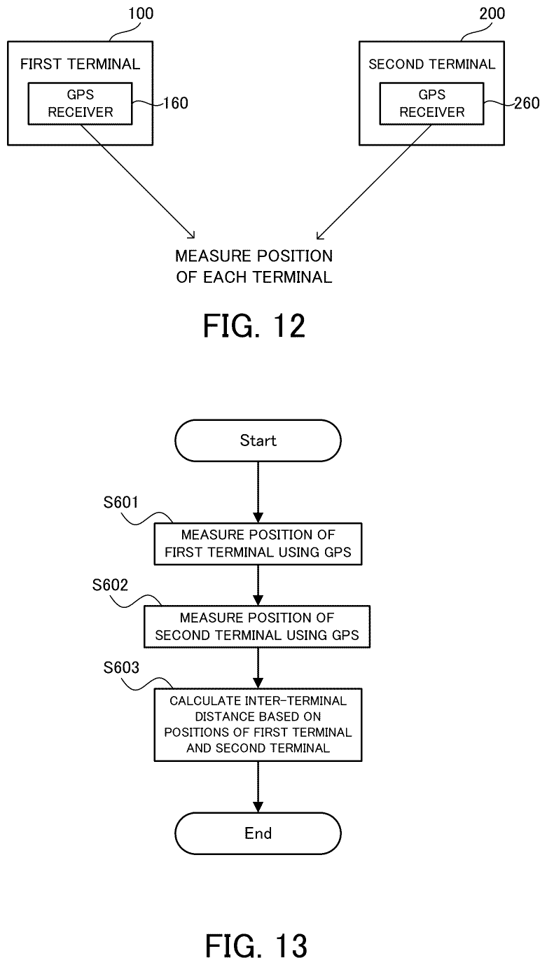

A sixth information processing system 10 will be described with reference to FIG. 12 and FIG. 13. Note that the sixth information processing system 10 partially differs from the second information processing system 10 described above only in its configuration and operation, and may be the same as the second information processing system 10 in the other parts. Therefore, the following description will focus on the parts differing from the previously described example embodiments, omitting explanations for other overlapping parts as appropriate.

### Terminal Configuration

First, with reference to FIG. 12, a terminal configuration of the sixth information processing system 10 will be described. FIG. 12 is a block diagram illustrating configurations of the first terminal and the second terminal in the sixth information processing system.

As illustrated in FIG. 12, the sixth information processing system 10 includes a GPS receiver 160 in the first terminal 100. The GPS receiver 160 is configured to receive signals from GPS satellites and detect the position of the first terminal 100. Furthermore, the fifth information processing system 10 also includes a GPS receiver 260 in the second terminal 200. The GPS receiver 260 is configured to receive signals from GPS satellites and detect the position of the second terminal 200.

The inter-terminal distance calculation unit 320 in the fifth information processing system is configured to calculate the inter-terminal distance, which is the distance between the first terminal 100 and the second terminal 200, based on the position of the first terminal 100 detected by the GPS receiver 160 and the position of the second terminal 200 detected by the GPS receiver 260. For example, the inter-terminal distance calculation unit 320 calculates the inter-terminal distance as a difference between the position of the first terminal 100 and the position of the second terminal 200.

### Distance Calculation Operation

Next, with reference to FIG. 13, a flow of the distance calculation operation in the sixth information processing system 10 will be described. FIG. 13 is a flowchart illustrating the flow of the distance calculation operation in the sixth information processing system.

As illustrated in FIG. 13, when the distance calculation operation in the sixth information processing system 10 is started, the inter-terminal distance calculation unit 320 first acquires the position of the first terminal 100 detected by the GPS receiver 160 in the first terminal 100 (Step S601). The inter-terminal distance calculation unit 320 also acquires the position of the second terminal 200 detected by the GPS receiver 260 in the second terminal 200 (Step S602).

Then, the inter-terminal distance calculation unit 320 calculates the inter-terminal distance, which is the distance between the first terminal 100 and the second terminal 200, based on the position of the first terminal 100 and the position of the second terminal 200 (Step S603). The inter-terminal distance calculated by the inter-terminal distance calculation unit 320 is then outputted to the determination unit 310.

### Technical Effect

Next, a technical effect obtained by the sixth information processing system 10 will be described.

As described in FIG. 12 and FIG. 13, in the sixth information processing system 10, the positions of the first terminal 100 and the second terminal 200 are measured using the GPS, and the inter-terminal distance is calculated based on the measured positions of the terminals. This enables accurate calculation of the inter-terminal distance with a simple configuration.

### Seventh Example Embodiment

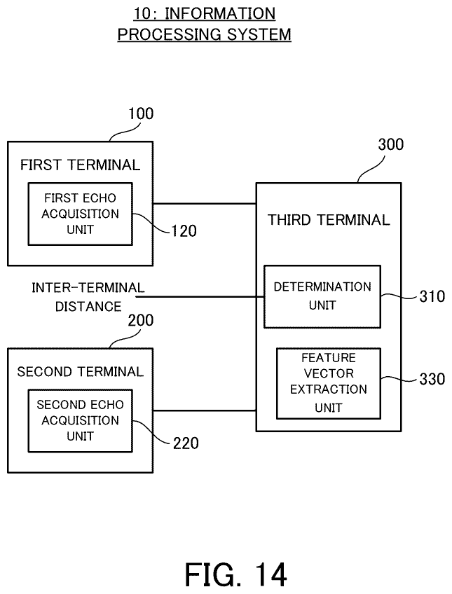

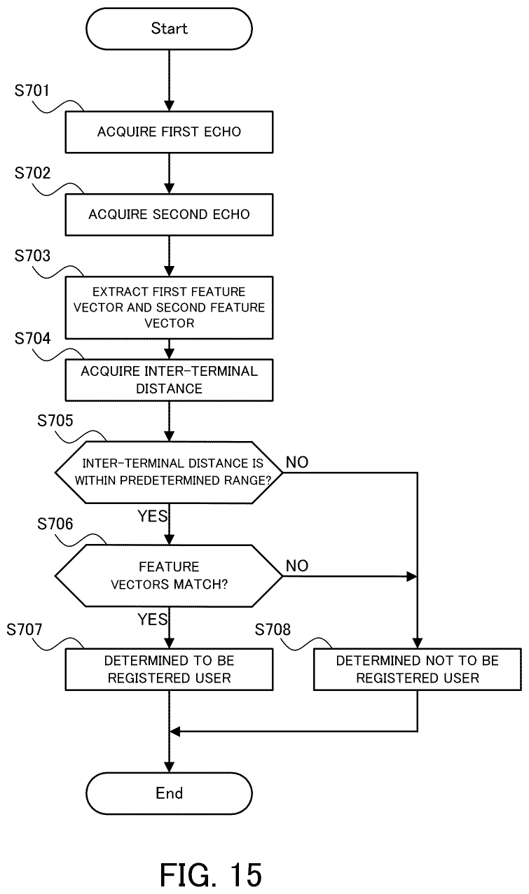

A seventh information processing system 10 will be described with reference to FIG. 14 and FIG. 15. Note that the seventh information processing system 10 partially differs from the first to sixth information processing systems 10 described above only in its configuration and operation, and may be the same as t the first to seventh information processing systems 10 in the other parts. Therefore, the following description will focus on the parts differing from the already described example embodiments, omitting explanations for other overlapping parts as appropriate.

### Terminal Configuration

First, with reference to FIG. 14, a terminal configuration of the seventh information processing system 10 will be described. FIG. 14 is a block diagram illustrating the terminal configuration of the seventh information processing system. Note that in FIG. 14, the same reference numerals are used for the same components as those illustrated in FIG. 2.

In FIG. 14, the seventh information processing system 10 includes the first terminal 100, the second terminal 200, and the third terminal 300. The first terminal 100 includes a first echo acquisition unit 120 as a processing block for realizing its functions. The first echo acquisition unit 120 is configured to acquire the first echo reverberating inside the target's first ear. The first echo acquisition unit 110 controls the first terminal 100 to transmit a sound wave into the target's first ear, and acquires an echo signal based on an echo of the transmitted sound wave. On the other hand, the second terminal 200 includes a second echo acquisition unit 220 as a processing block for realizing its function. The second echo acquisition unit 220 is configured to acquire the second echo reverberating inside the target's second ear, through an operation similar to that of the first echo acquisition unit 120 described above. The first echo acquired by the first echo acquisition unit 120 and the second echo acquired by the second echo acquisition unit 220 are configured to be outputted to the third terminal.

The third terminal 300 includes, as processing blocks for realizing its functions, the determination unit 310 and a feature vector extraction unit 330. That is, the third terminal 300 in the seventh information processing system further includes the feature vector extraction unit 330 in addition to the configuration described in the first example embodiment (see FIG. 2). The feature extraction unit 330 is configured to extract the first feature vector from the first echo acquired by the first echo acquisition unit 120. Furthermore, the feature vector extraction unit 330 is configured to extract the second feature vector from the second echo acquired by the second echo acquisition unit 220. The first feature vector and the second feature vector extracted by the feature vector extraction unit 330 are configured to be outputted to the determination unit 310.

### Authentication Operation

Next, with reference to FIG. 15, a flow of the authentication operation in the seventh information processing system 10 will be described. FIG. 15 is a flowchart illustrating a flow of the authentication operation in the seventh information processing system. In FIG. 15, the same reference numerals are used for the same steps as those illustrated in FIG. 3.

As illustrated in FIG. 5, when the authentication operation by the seventh information processing system 10 is started, the first echo acquisition unit 120 in the first terminal 100 first acquires the first echo reverberating in the target's first ear (step S701). Furthermore, the second echo acquisition unit 220 in the second terminal 200 acquires the second echo reverberating in the target's second ear (Step S702). The aforementioned Steps S701 and S702 may be performed sequentially in any order or simultaneously in parallel. Each of the first echo and the second echo is outputted to the third terminal 300.

Then, the feature vector extraction unit 330 in the third terminal extracts the first feature vector from the first echo acquired by the first echo acquisition unit 120. Furthermore, the feature vector extraction unit 330 extracts the second feature vector from the second echo acquired by the second echo acquisition unit 220 (step S703). Each of the first feature vector and the second feature vector is outputted to the determination unit 310.

Then, the determination unit 310 in the third terminal acquires the inter-terminal distance, which is the distance between the first terminal 100 and the second terminal 200 (Step S704). The determination unit 310 then determines whether or not the inter-terminal distance is within a predetermined range (Step S705). In a case where the inter-terminal distance is not within the predetermined range (Step S705: NO), the determination unit 310 determines that the target is not a registered user (Step S708).

In a case where the inter-terminal distance is within the predetermined range (Step S705: YES), the determination unit 310 determines whether or not the first feature vector and the second feature vector extracted by the feature extraction unit 330 match the feature quantities of a registered user that are registered in advance (Step S706). In a case where the first and second feature quantities match the feature quantities of a registered user (Step S706: YES), the determination unit 310 determines that the target is a registered user (Step S706). On the other hand, in a case where the first and the second feature quantities do not match the feature quantities of a registered user (Step S706: NO), the determination unit 310 determines that the target is not a registered user (Step S708).

### Technical Effect

Next, a technical effect obtained by the seventh information processing system 10 will be described.

As described in FIG. 14 and FIG. 15, in the seventh information processing system 10, the first echo and the second echo are acquired by the first terminal 100 and the second terminal 200, respectively, and the first feature vector and the second feature vector based on the first echo and the second echo are extracted at the third terminal 300. This may simplify the configurations of the first terminal 100 and the second terminal 200. Specifically, the first terminal 100 and the second terminal 200 may not be configured to extract the feature quantities from the echoes, it is possible to simplify the configurations of the first terminal 100 and the second terminal 200, compared with the configuration described in the first example embodiment (see FIG. 2).

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of SaaS (Software as a Service), for example.

### SUPPLEMENTARY NOTES

The example embodiments described above may be further described as, but not limited to, the following Supplementary Notes below.

### Supplementary Note 1

An information processing system according to Supplementary Note 1 is an information processing system including: a first acquisition unit that acquires a first feature vector based on a first echo reverberating in a first ear of a target; a second acquisition unit that acquires a second feature vector based on a second echo reverberating in a second ear of the target; and a determination unit that determines whether to authenticate the target, based on the first feature vector, the second feature vector, and a distance between the first acquisition unit and the second acquisition unit.

### Supplementary Note 2

An information processing system according to Supplementary Note 2 is the information processing system according to Supplementary Note 1, further including: a distance calculation unit that calculates the distance between the first acquisition unit and the second acquisition unit.

### Supplementary Note 3

An information processing system according to Supplementary Note 3 is the information processing system according to Supplementary Note 2, wherein the distance calculation unit calculates the distance between the first acquisition unit and the second acquisition unit, based on a sound propagation time between the first acquisition unit and the second acquisition unit.

### Supplementary Note 4

An information processing system according to Supplementary Note 4 is the information processing system according to Supplementary Note 3, wherein the distance calculation unit calculates the distance between the first acquisition unit and the second acquisition unit, based on the sound propagation time via bone conduction between the first acquisition unit and the second acquisition unit.

### Supplementary Note 5

An information processing system according to Supplementary Note 5 is the information processing system according to Supplementary Note 2, further including: a reference terminal that is different from the first acquisition unit and the second acquisition unit, wherein the distance calculation unit calculates the distance between the first acquisition unit and the second acquisition unit, based on a sound propagation time between the first acquisition unit and the reference terminal and a sound propagation time between the second acquisition unit and the reference terminal.

### Supplementary Note 6

An information processing system according to Supplementary Note 6 is the information processing system according to Supplementary Note 2, wherein the distance calculation unit calculates a moving distance of at least one of the first acquisition unit and the second acquisition unit using an acceleration sensor provided in at least one of the first acquisition unit and the second acquisition unit, and calculates the distance between the first acquisition unit and the second acquisition unit based on the moving distance.

### Supplementary Note 7

An information processing system according to Supplementary Note 7 is the information processing system according to Supplementary Note 2, wherein the distance calculation unit detects positions of the first acquisition unit and the second acquisition unit using a GPS (Global Positioning System), and calculates the distance between the first acquisition unit and the second acquisition unit, based on the positions of the first acquisition unit and the second acquisition unit.

### Supplementary Note 8

An information processing system according to Supplementary Note 8 is an information processing system including: a first acquisition unit that acquires a first echo reverberating in a first ear of a target; a second acquisition unit that acquires a second echo reverberating in a second ear of the target; an extraction unit that extracts a first feature vector from the first echo and extracts a second feature vector from the second echo; and a determination unit that determines whether to authenticate the target, based on the first feature vector, the second feature vector, and a distance between the first acquisition unit and the second acquisition unit.

### Supplementary Note 9

An information processing method according to Supplementary Note 9 is an information processing method including: acquiring a first feature vector based on a first echo reverberating in a first ear of a target, via a first acquisition unit; acquiring a second feature vector based on a second echo reverberating in a second ear of the target, via a second acquisition unit; and determining whether to authenticate the target, based on the first feature vector, the second feature vector, and a distance between the first acquisition unit and the second acquisition unit.

### Supplementary Note 10

A recording medium according to Supplementary Note 10 is a recording medium on which a computer program that allows execution of an information processing method is recorded, the information processing method including: acquiring a first feature vector based on a first echo reverberating in a first ear of a target, via a first acquisition unit; acquiring a second feature vector based on a second echo reverberating in a second ear of the target, via a second acquisition unit; and determining whether to authenticate the target, based on the first feature vector, the second feature vector, and a distance between the first acquisition unit and the second acquisition unit.

### Supplementary Note 11

A computer program according to Supplementary Note 11 is a computer program that allows execution of an information processing method, the information processing method including: acquiring a first feature vector based on a first echo reverberating in a first ear of a target, via a first acquisition unit; acquiring a second feature vector based on a second echo reverberating in a second ear of the target, via a second acquisition unit; and determining whether to authenticate the target, based on the first feature vector, the second feature vector, and a distance between the first acquisition unit and the second acquisition unit.

### Supplementary Note 12

An information processing system according to Supplementary Note 12 is the information processing system according to Supplementary Note 8, further including: a distance calculation unit that calculates the distance between the first acquisition unit and the second acquisition unit.

### Supplementary Note 13

An information processing system according to Supplementary Note 13 is the information processing system according to Supplementary Note 12, wherein the distance calculation unit calculates the distance between the first acquisition unit and the second acquisition unit, based on a sound propagation time between the first acquisition unit and the second acquisition unit.

### Supplementary Note 14

An information processing system according to Supplementary Note 14 is the information processing system according to Supplementary Note 13, wherein the distance calculation unit calculates the distance between the first acquisition unit and the second acquisition unit, based on the sound propagation time via bone conduction between the first acquisition unit and the second acquisition unit.

### Supplementary Note 15

An information processing system according to Supplementary Note 15 is the information processing system according to Supplementary Note 12, further including: a reference terminal that is different from the first acquisition unit and the second acquisition unit, wherein the distance calculation unit calculates the distance between the first acquisition unit and the second acquisition unit, based on a sound propagation time between the first acquisition unit and the reference terminal and a sound propagation time between the second acquisition unit and the reference terminal.

### Supplementary Note 16

An information processing system according to Supplementary Note 16 is the information processing system according to Supplementary Note 12, wherein the distance calculation unit calculates a moving distance of at least one of the first acquisition unit and the second acquisition unit using an acceleration sensor provided in at least one of the first acquisition unit and the second acquisition unit, and calculates the distance between the first acquisition unit and the second acquisition unit based on the moving distance.

### Supplementary Note 17

An information processing system according to Supplementary Note 17 is the information processing system according to Supplementary Note 12, wherein the distance calculation unit detects positions of the first acquisition unit and the second acquisition unit using a GPS (Global Positioning System), and calculates the distance between the first acquisition unit and the second acquisition unit, based on the positions of the first acquisition unit and the second acquisition unit.

### Supplementary Note 18

An information processing method according to Supplementary Note 18 is an information processing method including: acquiring a first echo reverberating in a first ear of a target, via a first acquisition unit; acquiring a second echo reverberating in a second ear of the target, via a second acquisition unit; extracting a first feature vector from the first echo and extracting a second feature vector from the second echo; and determining whether to authenticate the target, based on the first feature vector, the second feature vector, and a distance between the first acquisition unit and the second acquisition unit.

### Supplementary Note 19

A recording medium according to Supplementary Note 19 is a recording medium on which a computer program that allows execution of an information processing method is recorded, the information processing method including: acquiring a first echo reverberating in a first ear of a target, via a first acquisition unit; acquiring a second echo reverberating in a second ear of the target, via a second acquisition unit; extracting a first feature vector from the first echo and extracting a second feature vector from the second echo; and determining whether to authenticate the target, based on the first feature vector, the second feature vector, and a distance between the first acquisition unit and the second acquisition unit.

### Supplementary Note 20

A computer program according to Supplementary Note 20 is a computer program that allows execution of an information processing method, the information processing method including: acquiring a first echo reverberating in a first ear of a target, via a first acquisition unit; acquiring a second echo reverberating in a second ear of the target, via a second acquisition unit; extracting a first feature vector from the first echo and extracting a second feature vector from the second echo; and determining whether to authenticate the target, based on the first feature vector, the second feature vector, and a distance between the first acquisition unit and the second acquisition unit.

The present disclosure is allowed to be changed, if desired, without departing from the essence or spirit of this disclosure which can be read from the claims and the entire specification. An information processing system, an information processing method, and a recording medium with such changes are also intended to be within the technical scope of the present disclosure.

### DESCRIPTION OF REFERENCE CODES

10 Information processing system
11 Processor
100 First terminal
110 First feature vector acquisition unit
120 First echo acquisition unit
150 Acceleration sensor
160 GPS receiver
200 Second terminal
210 Second feature vector acquisition unit
220 Second echo acquisition unit
250 Acceleration sensor
260 GPS receiver
300 Third terminal
310 Determination unit
320 Inter-terminal distance calculation unit
330 Feature vector extraction unit

What is claimed is:

1. An information processing system comprising:
at least one memory that is configured to store instructions; and
at least one processor that is configured to execute the instructions to:
acquire a first feature vector based on a first echo reverberating in a first ear of a target, via a first acquisition unit;
acquire a second feature vector based on a second echo reverberating in a second ear of the target, via a second acquisition unit; and
determine whether to authenticate the target, based on the first feature vector, the second feature vector, and a distance between the first acquisition unit and the second acquisition unit.

2. The information processing system according to claim 1, wherein the at least one processor is configured to execute the instructions to:
calculate the distance between the first acquisition unit and the second acquisition unit.

3. The information processing system according to claim 2, wherein the at least one processor is configured to execute the instructions to:
calculate the distance between the first acquisition unit and the second acquisition unit, based on a sound propagation time between the first acquisition unit and the second acquisition unit.

4. The information processing system according to claim 3, wherein the at least one processor is configured to execute the instructions to:
calculate the distance between the first acquisition unit and the second acquisition unit, based on the sound propagation time via bone conduction between the first acquisition unit and the second acquisition unit.

5. The information processing system according to claim 2, further comprising:
a reference terminal that is different from the first acquisition unit and the second acquisition unit, wherein the at least one processor is configured to execute the instructions to:
calculate the distance between the first acquisition unit and the second acquisition unit, based on a sound propagation time between the first acquisition unit and the reference terminal and a sound propagation time between the second acquisition unit and the reference terminal.

6. The information processing system according to claim 2, wherein the at least one processor is configured to execute the instructions to:
calculate a moving distance of at least one of the first acquisition unit and the second acquisition unit using an acceleration sensor provided in at least one of the first acquisition unit and the second acquisition unit, and calculate the distance between the first acquisition unit and the second acquisition unit based on the moving distance.

7. The information processing system according to claim 2, wherein the at least one processor is configured to execute the instructions to:
detect positions of the first acquisition unit and the second acquisition unit using a GPS (Global Positioning System), and calculate the distance between the first acquisition unit and the second acquisition unit, based on the positions of the first acquisition unit and the second acquisition unit.

8. (Canceled)

9. An information processing method comprising:
acquiring a first feature vector based on a first echo reverberating in a first ear of a target, via a first acquisition unit;
acquiring a second feature vector based on a second echo reverberating in a second ear of the target, via a second acquisition unit; and
determining whether to authenticate the target, based on the first feature vector, the second feature vector, and a distance between the first acquisition unit and the second acquisition unit.

10. A non-transitory recording medium on which a computer program that allows execution of an information processing method is recorded, the information processing method including:
acquiring a first feature vector based on a first echo reverberating in a first ear of a target, via a first acquisition unit;
acquiring a second feature vector based on a second echo reverberating in a second ear of the target, via a second acquisition unit; and
determining whether to authenticate the target, based on the first feature vector, the second feature vector, and a distance between the first acquisition unit and the second acquisition unit.
